(19) United States
(12) Patent Application Publication
(10) Pub. No.: US 2026/0230093 A1
(43) Pub. Date: Aug. 6, 2026

(54) CONDITIONAL SWITCHING AMONG ANTENNA ARRAYS

(71) Applicant: Swift Beat, LLC, Menlo Park, CA (US)

(72) Inventor: Joseph A. KAISER, Hopkinton, MA (US)

(21) Appl. No.: 19/467,719

(22) Filed: Feb. 2, 2026

Related U.S. Application Data
(60) Provisional application No. 63/753,355, filed on Feb. 3, 2025.
(60) Provisional application No. 63/961,400, filed on Jan. 15, 2026.

(51) Int. Cl. H04B 1/00; H01Q 3/24; H04B 17/318

(52) U.S. Cl. CPC H04B 1/0003; H01Q 3/24; H04B 17/318

(57) ABSTRACT

Systems and methods are provided for dynamically configuring antenna arrays on a mobile platform to support both broad area scanning and high-accuracy target identification using minimal hardware resources. The system employs a combination of sparse antenna arrays and uniform linear antenna arrays and selectively switches between scanning and targeting modes based on operational conditions. A single radio frequency front end (RFFE) board processes signals from multiple antenna arrays and includes an RF multiplexer and a software-defined radio (SDR) to enable rapid reconfiguration of signal paths. Control logic dynamically reallocates signal processing resources between a scanning antenna array and a targeting antenna array to transition between wide-area signal detection and focused target tracking.

### CROSS-REFERENCE TO RELATED APPLICATION

This application claims the benefit of U.S. Provisional Application No. 63/753,355 filed Feb. 3, 2025, and U.S. Provisional Application No. 63/961,400 filed Jan. 15, 2026, the entireties of which are hereby incorporated by reference herein.

### BACKGROUND

Efficient data transmission is a critical challenge in the field of communication systems. Some conventional systems employ phased-array antenna designs for signal processing, but these often demand significant hardware resources and can be limited by their need for extensive electronic integration. These systems require extensive hardware requirements to support multiple antenna configurations, resulting in increased weight and energy consumption, which are undesirable in some applications. Existing systems with fixed antenna configurations also struggle to efficiently transition between different modes of operation, such as broad area scanning and high accuracy targeting.

In addition, conventional systems frequently rely on uniform linear arrays (ULAs) to achieve desired scanning and tracking functionalities, leading to challenges in hardware complexity, resource allocation, and adaptability to rapidly changing environments. While sparse arrays reduce the number of necessary elements in an antenna system, these are often plagued by issues such as ambiguities in target detection and increased possibilities of false positives.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

Systems and methods for switching between antenna arrays are provided. A plurality of signals is received from a first set of antennas. A target signal is identified from the plurality of signals, and based on identifying the target signal, switching to a second set of antennas having increased directional tracking capability relative to the first set of antennas. The target signal is tracked with the second set of antennas until a first switching condition is detected, and upon detecting the first switching condition, switching back to the first set of antennas. The target signal is then tracked with the first set of antennas until a second switching condition is detected, and upon detecting the second switching condition, switching back to the second set of antennas. Thereafter, the target signal is tracked with the second set of antennas until a third switching condition is detected or an objective is completed.

### BRIEF DESCRIPTION OF THE DRAWINGS

The present description will be better understood from the following detailed description read considering the accompanying drawings, wherein:

FIG. 1 is a block diagram illustrating a system configured for switching between antenna arrays;

FIG. 2 is a block diagram illustrating an antenna architecture;

FIGS. 3A-3F are diagrams of exemplary antenna grid patterns;

FIG. 4 is a flowchart illustrating a method for switching between antenna arrays;

FIGS. 5A-5E are exemplary diagrams of a 16-element antenna; and

FIG. 6 is a block diagram of an example computing apparatus for implementing examples of the present disclosure.

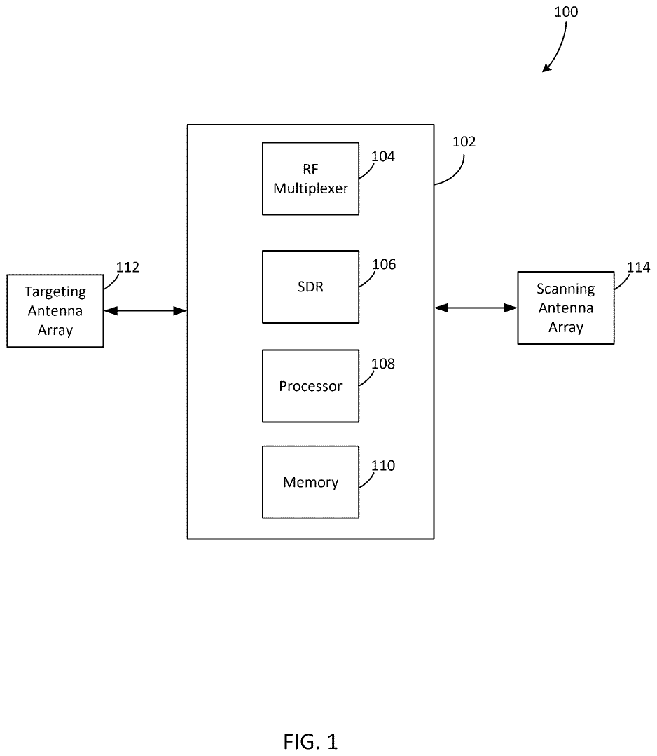

Corresponding reference characters indicate corresponding parts throughout the drawings. In FIGS. 1 to 6, the systems are illustrated as schematic drawings. The drawings may not be to scale. Any of the figures may be combined into a single example or embodiment.

### DETAILED DESCRIPTION

Aspects of the disclosure include an improved system that utilizes a combination of sparse and uniform linear arrays of antennas for improved target identification and resource optimization in mobile platforms. The system dynamically switches between broad area scanning and high accuracy targeting using minimal hardware resources, unlike traditional systems which require extensive electronic integration. In some examples, the dynamic switching between a scanning array of antennas and a targeting array of antennas is facilitated through a single board setup that processes inputs from two sets of 1×4 antenna arrays. The system allows seamless transition between broad area scanning functionality and high accuracy targeting functionality.

The system features a single radio frequency front end (RFFE) board for processing inputs from distinct antenna arrays, achieving fast reconfiguration without substantial hardware. An example RFFE includes an 8-channel RF multiplexer and a 4-channel software-defined radio (SDR), allowing flexible and efficient signal handling. For example, to transition from scanning to targeting, control logic initiates a command sequence that reconfigures the input paths on the RFFE board to direct the signal processing resources from the scanning array of antennas to the targeting array of antennas. Similarly, for transitioning from targeting back to scanning, the control logic reverses the configuration paths, reallocating the necessary signal processing resources.

Aspects of the disclosure are operable in a wide range of applications, such as air traffic management, disaster response and recovery efforts, and search and rescue. In an air traffic management example, the dynamic antenna configuration and switching system enhances air traffic management systems by improving the precision of aircraft monitoring and communication. This offers better coordination and tracking of commercial aircraft in congested airspace, and improves safety and efficiency in air travel. In a disaster response example, the system's capability for rapid area scanning and precise target identification is deployed to manage and coordinate relief operations. This includes monitoring and identifying specific areas or objects of interest, such as locating survivors or assessing infrastructure damage in real-time. In a search and rescue example, the system switches operation between scanning and targeting to locate one or more rescue beacons, such as from a lost hiker or skier.

An example implementation includes two orthogonally arranged 1×4 antenna arrays, wherein a first antenna array serves as a broad area scanning array, capable of covering extensive aerial regions for initial target acquisition, and a second antenna array functions as a high-accuracy targeting array to provide precise data related to specific targets once identified by the scanning array. The system supports dynamic switching between these arrays, depending on real-time operational needs. Such capability facilitates effective signal processing with minimal hardware footprint, improving efficiency in resource allocation. In other examples, the 1×4 antennas arrays are linearly arranged, and not orthogonally arranged.

While described for convenience in the context of two antenna arrays, aspects of the disclosure are operable with any quantity of antenna arrays. For example, the system is operable to switch among three or more antenna arrays.

In another implementation, the system includes a sparse array and a uniform linear array (ULAs) on the mobile platform to enhance the reliability of target identification while reducing hardware complexity. The integration is orchestrated such that the sparse arrays act initially to cover a large volume for target indication, with the ULA refining the signal analysis to confirm real targets, mitigating false positives. In this implementation, the ULA is a one-dimensional (1D) antenna array, while the sparse array is a 1D antenna array or a 2D antenna array. As such, the antennas in a 1D sparse array are arranged along a single axis with spacing between the antennas being irregular and/or larger than the ULA antenna spacing (e.g., greater than λ/ 2), while the antennas in a 2D sparse array are arranged in a plane (e.g., rectangular or circular grid) with spacing between the antennas being irregular and/or larger than the ULA antenna spacing (e.g., greater than λ/2).

In another implementation, there is an emphasis on beamforming techniques integrated with an SDR as part of the signal processing infrastructure to facilitate synchronized beamform management across diverse frequencies and communication bands, supporting rapid signal adaptation. The multiplexer enables swift input switching between different antenna outputs, optimizing the response times for changing communication or tracking requirements without extensive manual reconfiguration.

In another implementation, antenna multiplexing may be extended and expanded such that, for a 16-element antenna, a multitude of four antenna groups, or combinations of up to four antenna connections, may be selected and routed to the SDR via a 16-channel multiplexer (e.g., a 16:4 mux or 16:1 mux). This will enable more combinations than that provided by the 8×4 antenna, such as up to eight ULAs and a greater number of sparse arrays. In addition, this implementation has the advantages of selecting offset phase discriminations of the orthogonal ULAs, which can be used to determine potential phase ambiguities. This capability along with advanced signal processing can be used to solve for greater antenna angular accuracy, side lobe cancellation, and phase ambiguity resolution.

In another implementation, the system described herein incorporates adaptive signal filtering mechanisms to provide versatility in managing various frequency bands. A set of switchable filter banks is employed to selectively mitigate interference or jamming conditions, thus preserving signal clarity. The filtering strategy is dynamically adjusted based on detected environmental noise or interference profiles, ensuring optimal signal bandwidth selection without additional manual intervention.

In another implementation, different antenna array elements are combined to maximize beam pattern efficiency. The adaptability is enabled by switching logic that evaluates environmental conditions such as noise levels or changes in a flight path. The system dynamically selects between spotlight (target-focused) and floodlight (broad area scanning) modes based on real-time data inputs.

An exemplary technical effect of the system, apparatus, and method described herein is to enhance the efficiency and precision of data processing and target identification in aerial communication systems while minimizing hardware resource utilization. By integrating sparse and uniform linear phased-array designs, the system achieves dynamic configuration with the capability for rapid switching between broad area scanning and high-accuracy targeting. This reduces the electronic component requirements, mitigates false target identification, and ensures adaptability to diverse and changing conditions. Furthermore, the system supports flexible and efficient signal processing across multiple communication bands, employing sophisticated beamforming techniques and adaptive filtering to optimize signal clarity and performance in environments subject to interference.

Referring to the figures, FIG. 1 is a block diagram illustrating an antenna system 100. In some examples, the antenna system 100 is implemented in a mobile platform, such as an aircraft, uncrewed aerial vehicle (UAV), land vehicle, marine vehicle, space vehicle, balloon, and the like. In other examples, the antenna system 100 is implemented in a stationary platform.

The antenna system 100 includes an RFFE board 102 comprising an RF multiplexer 104, an SDR 106, a processor 108, and a memory 110. In some examples, the RFFE board 102 is a single board configured to process signals from two sets of antennas, such as targeting antenna array 112 and scanning antenna array 114. More specifically, the RF multiplexer 104 has a plurality of antenna ports for connecting with the targeting antenna array 112 and the scanning antenna array 114 enabling the SDR 106 to process signals from the targeting antenna array 112 and the scanning antenna array 114.

Exemplary signals that are followed, targeted, tracked, or otherwise identified by the system and method described herein include beacon signals, communication signals, radar echoes, emitter signals, and environmental monitoring signals. In some examples, an emitter signal, such as a global positioning system (GPS) signal emitted from a beacon, is used as a reference point for navigation, target acquisition, and/or communication purposes. In some examples, communication signals are followed across various communication bands and frequencies, supporting communication among mobile platforms and/or ground stations. In some examples, radar echoes are reflected from objects aiding in target detection and tracking. In some examples, environmental monitoring signals representing environmental data such as atmospheric conditions or terrain features are followed. In some examples, sources of interference or jamming signals are identified and tracked to implement adaptive filtering, and to mitigate their effects.

In some examples, the targeting antenna array 112 and the scanning antenna array 114 are designed to receive a particular type of signal(s) with particular characteristics. For example, a distance between antennas in the first set of antennas is based on a frequency of operation and a purpose of the first set of antennas. In some examples, the spacing is based on a wavelength (λ) of the signal, which is inversely proportional to the frequency.

In some examples, the antennas are spaced approximately half a wavelength apart (e.g., λ/2). This minimizes grating lobes (undesirable side lobes in the radiation pattern), ensures constructive interference in the desired direction for beamforming, and provides optimal directional performance. For example, for a frequency of 2.4 GHz (λ=12.5 cm), the antennas are spaced about 6.25 cm apart.

In some examples, the antennas have a full wavelength spacing (e.g., λ) for less sensitive applications or where mutual coupling (e.g., interference between antennas) needs to be reduced. However, this results in slightly larger side lobes compared to λ/2 spacing and less precise beamforming.

In some examples, the antennas have sub-wavelength spacing (e.g., <λ/2). The sub-wavelength spacing may be used in compact antenna arrays or for ultra-wideband and MIMO (multiple input multiple output) systems. While this can result in reduced mutual coupling and enables smaller form factor designs, sub-wavelength spacing may require advanced signal processing to handle the interactions between closely spaced elements.

In some examples, the antennas have larger spacing (e.g., >λ\2). This spacing is used in sparse arrays or for applications prioritizing aperture size over array density, which can provide higher resolution for specific applications (e.g., radio astronomy).

To achieve effective signal processing with minimal hardware footprint while also improving efficiency in computing and electronic resource allocation, the targeting antenna array 112 and the scanning antenna array 114 in some examples each include only 4 antennas (e.g., 8 total). The targeting antenna array 112 is designed with elements positioned to achieve a specific goal, such as maximizing directional gain, minimizing interference, and/or focusing energy in a particular direction. The spacing between each of the 4 antennas is uniform or optimized for the desired beamforming pattern. The scanning antenna array 114 is designed with the antennas spaced farther apart than the targeting antenna array 112, often irregularly or with significant gaps. This configuration not only reduces the number of antennas but maintains coverage over a wide area while minimizing cost and complexity.

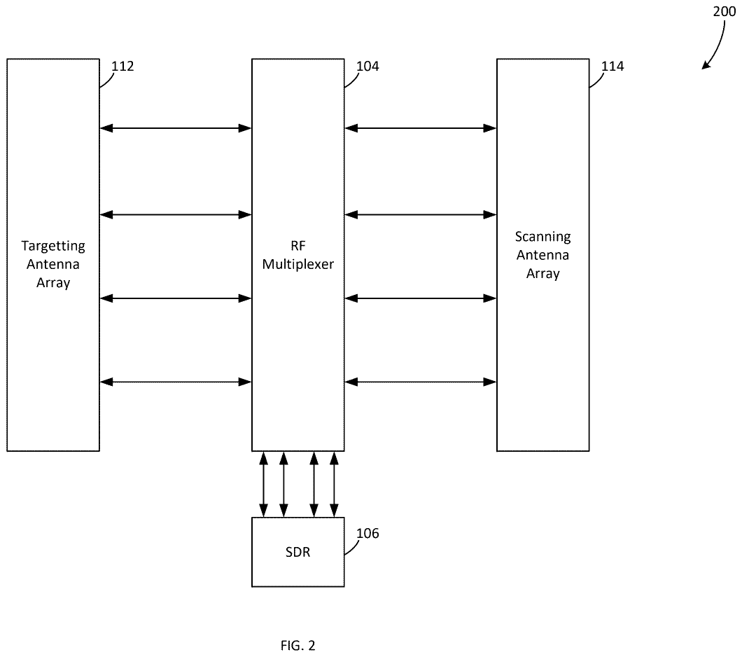

With reference now to FIG. 2, an example antenna architecture 200 is provided, wherein the RF multiplexer 104 is an 8-channel multiplexer (e.g., an 8:4 mux or an 8:1 mux) and the SDR 106 is a 4-channel SDR. The 8-channel multiplexer 104 is used to route signals from 8 different inputs (in this case, each of the 8 antennas in the targeting antenna array 112 and the scanning antenna array 114) to fewer outputs. In this example, the 4-channel SDR 106 has 4 input/output channels for signal processing. The 8-channel multiplexer 104 manages which of the 8 antennas are routed to the 4 SDR channels by dynamically selecting which antennas to connect to the SDR channels. As such, the 4-channel SDR 106 handles 4 out of the 8 available antennas at any given time, enabling the 4-channel SDR 106 to process signals from any combination of 8 antennas from the targeting antenna array 112 and the scanning antenna array 114, but only 4 at a time. In some examples, the 4-channel SDR 106 instructs the 8-channel multiplexer 104 which of the 8 antennas are to be selected. For example, the 8-channel multiplexer 104 switches between different antenna inputs allowing signals from the 8 antennas to be directed to available SDR channels at various times. In the illustrated examples, the SDR 106 is a 4-channel SDR. As such, the 8-channel multiplexer 104 selects 4 or less antenna signals to pass to the 4-channel SDR 106. In some examples, the 8-channel multiplexer 104 selects all 4 antennas from the targeting antenna array 112 or all 4 antennas from the scanning antenna array 114.

In some examples, the 8-channel multiplexer 104 selects less than 4 antennas from the targeting antenna array 112 or less than 4 antennas from the scanning antenna array 114. Various example configurations include 3 antennas from the targeting antenna array 112 and 0 antennas from the scanning antenna array 114, 2 antennas from the targeting antenna array 112 and 0 antennas from the scanning antenna array 114, 1 antenna from the targeting antenna array 112 and 0 antennas from the scanning antenna array 114, 0 antennas from the targeting antenna array 112 and 3 antennas from the scanning antenna array 114, 0 antennas from the targeting antenna array 112 and 2 antennas from the scanning antenna array 114, 0 antennas from the targeting antenna array 112 and 1 antenna from the scanning antenna array 114.

In some examples, the 8-channel multiplexer 104 selects less than 4 antennas from the targeting antenna array 112 and less than 4 antennas from the scanning antenna array 114. For example, 1-3 antennas from the targeting antenna array 112 and 1 antenna from the scanning antenna array 114, 1 or 2 antennas from the targeting antenna array 112 and 1 or 2 antennas from the scanning antenna array 114, or 1 antenna from the targeting antenna array 112 and 1-3 antennas from the scanning antenna array 114.

As explained above, each of the targeting antenna array 112 and the scanning antenna array 114 includes 4 antennas. However, the configuration (e.g., the spatial arrangements/layout) between the antennas of each of the targeting antenna array 112 and the scanning antenna array 114 may be different. In some examples, the targeting antenna array 112 and the scanning antenna array 114 are two orthogonal 1×4 antenna arrays. The scanning antenna array 114 functions as a broad area scanning array, while the targeting antenna array 112 functions as a high accuracy targeting array. In some examples, the antenna system 100 comprises sparse arrays with uniform linear arrays to reduce electronic component requirements. This design allows for target identification by cross-referencing different sparse array outputs, improving reliability in distinguishing real targets from ambiguities or false targets.

To optimize performance of the antenna system 100 comprising 8 antennas in a mobile platform, the optimal placement of the antennas considers factors such as aerial dynamics, line-of-sight, and coverage area. In some examples, the targeting antennas array 112 is placed along one or more wings of a mobile platform or towards the front end (e.g., nose) of the mobile platform. In some examples, the scanning antenna array is placed toward the tail of the mobile platform (e.g., behind the wings).

In some examples, the targeting antenna array 112 and the scanning antenna array 114 are a combination of Uniform Linear Phased Array (ULPA), sparse arrays, crossed dipole arrays, circular phased arrays, and/or hybrid arrays. In some examples, antenna elements are equidistantly positioned in a linear arrangement, allowing for effective phase steering. This facilitates adjustments in the beam direction by modifying the phase differences between elements, for example, by adjusting phase angles of the antennas to follow a trajectory of a target signal. The ULPA design is particularly adept at providing uniform coverage in the azimuth or elevation plane, thereby enhancing the phase angle differentiation necessary for precise beacon signal tracking. In some examples, by strategically spacing antenna elements with non-uniform distances, sparse arrays reduce the number of required hardware elements while maintaining adequate coverage for signal tracking. Although sparse arrays may be subject to ambiguity, intentional spacing patterns minimize this effect, supporting targeted tracking where electronic component constraints exist. Antenna arrays comprising pairs of dipoles arranged in orthogonal orientations offer dual-plane coverage, enhancing phase angle differentiation. The intersecting dipole orientations enable the system to concurrently track signals from various directions, supporting robust beacon tracking when differentiated phase angles are critical for angular resolution. One or more antenna arrays include an example configuration where antenna elements are uniformly distributed along a circular path, providing isotropic phase coverage. This allows for continuous 360-degree beamforming capabilities, offering high accuracy in tracking beacon signals from varying incident angles through dynamic phase adjustments. In some examples, a combination of sparse arrays with uniform grid patterns provides the ability to integrate advantageous aspects of both configurations. Sparse elements enhance coverage area flexibility, while uniformly spaced elements refine phase differentiation for precise tracking. Such hybrid configurations are tailored to adapt to specific constraints or environments, aligning with desired tracking performance outcomes.

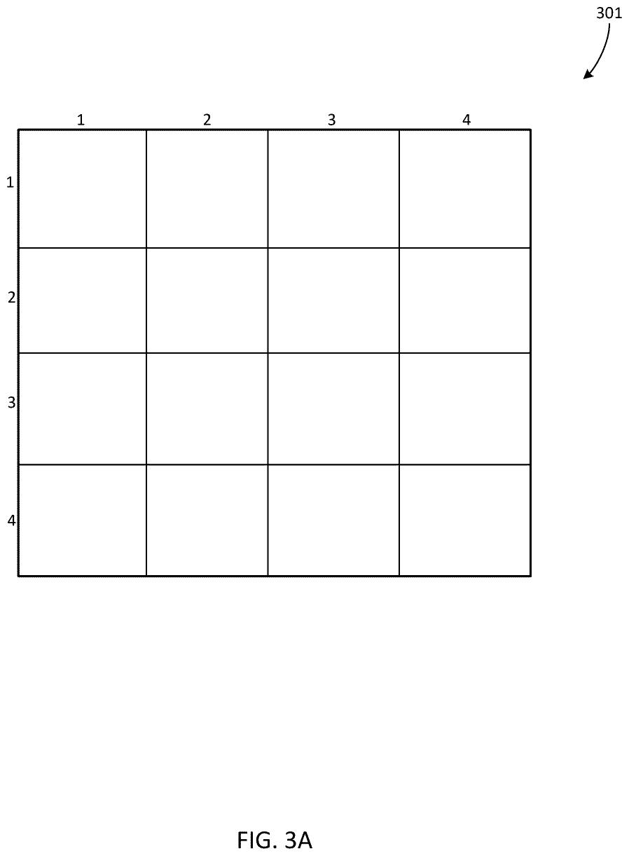

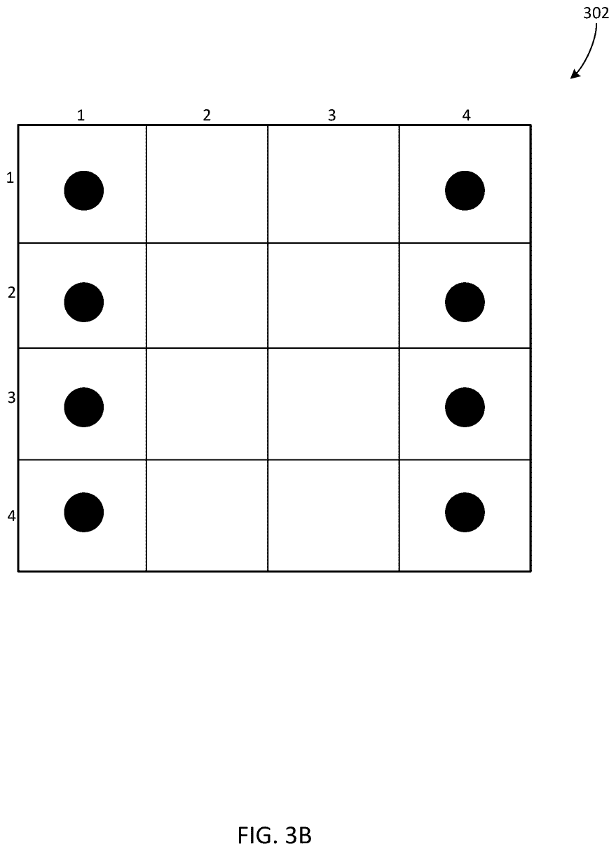

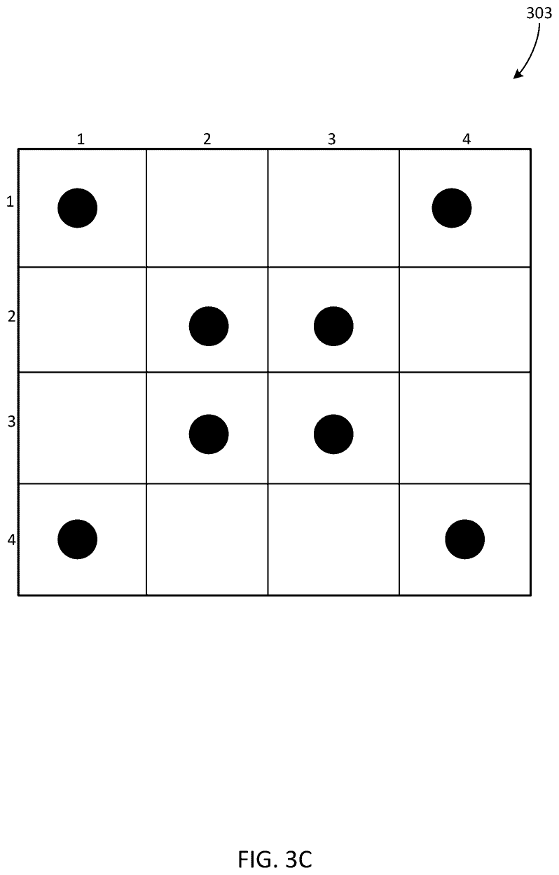

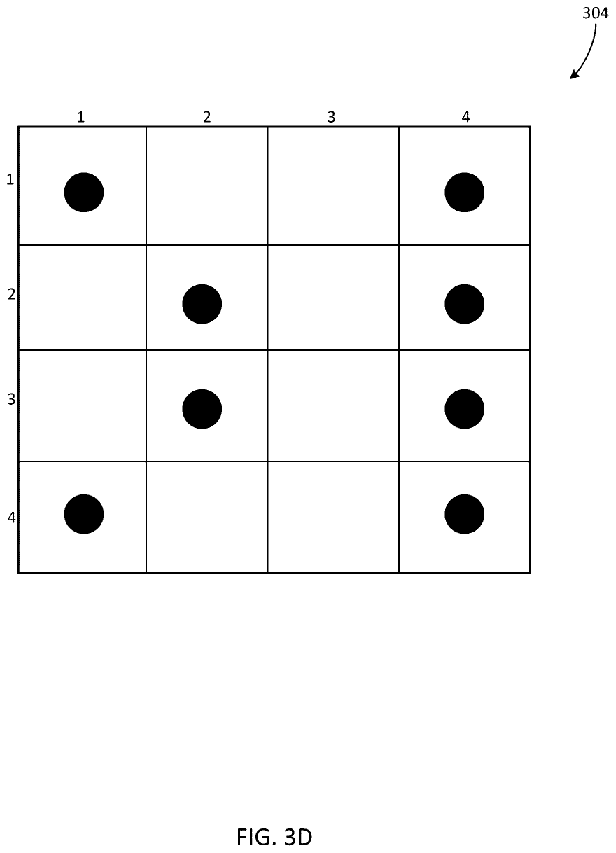

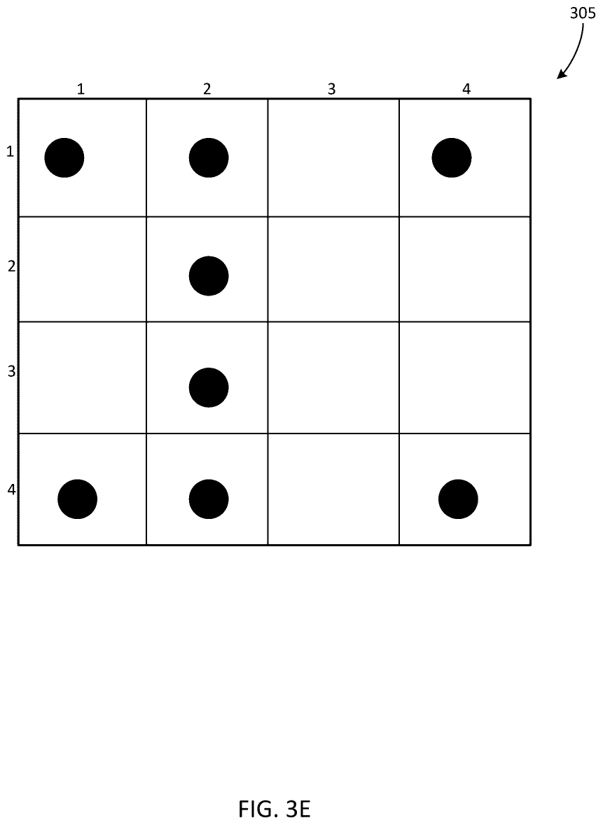

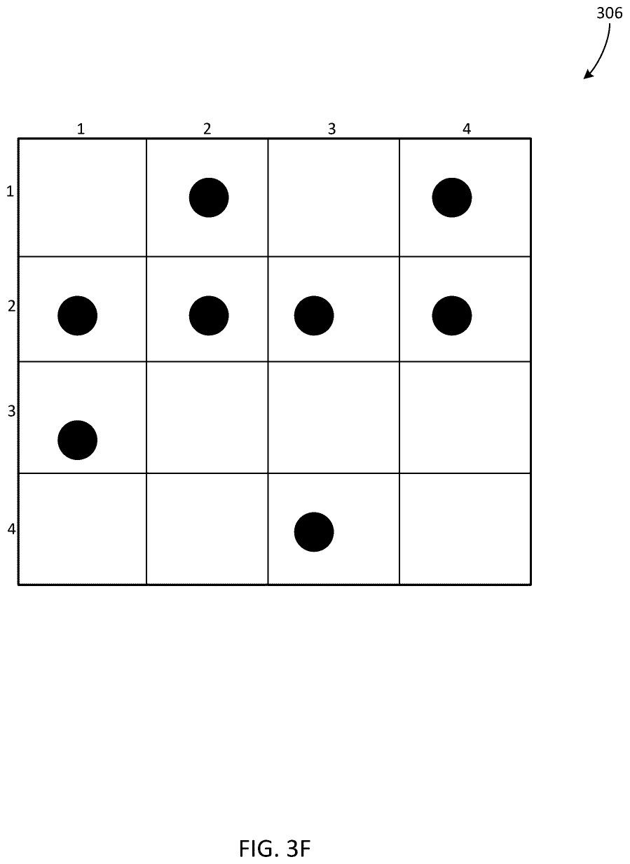

With reference now to FIG. 3A, in some examples, a grid pattern 301 of a 4×4 sparse array is used (e.g., for the scanning antenna array 114). In the context of a 4×4 sparse array system utilizing only four antennas, placement for these 4 antennas is designed to maximize coverage and enhance phase angle differentiation while minimizing the impact of potential ambiguities typically associated with sparse array configurations. The following example placement strategies optimize the 4×4 sparse array's performance within the constraints of employing only four antennas (e.g., on the scanning antenna array 114) while focusing on maximizing directional gain and effective coverage.

In some examples, the 4 antennas are advantageously placed in locations already designated/allotted for 4 of the 16 antennas in a typical 4×4 sparse array. Thus, in some examples, 4 antennas are positioned at opposite corners of the 4×4 grid, specifically at the coordinates (1,1), (1,4), (4,1), and (4,4). This layout maximizes the distance and phase separation between individual elements, which contributes to enhanced beamform steering capabilities and minimizes mutual coupling effects. In some examples, the 4 antennas are arranged linearly but non-adjacently, such as placing them at (1,1), (1,3), (3,1), and (3,3). This setup provides balanced spatial diversity and phase differentiation while maintaining sufficient space between elements to reduce redundancy in the main beam patterns. In some examples, the 4 antennas are arranged in a cross pattern with coordinates (2,1), (2,4), (1,2), and (4,2). This configuration leverages central symmetry and maintains a uniform distribution across the grid, facilitating broader area scanning advantages and providing structural diversity to counteract potential side lobes.

In some examples, instead of having the targeting antenna array 112 with 4 antennas and the scanning antenna array 114 with 4 antennas in two very separate locations on a mobile platform, all 8 of the antennas are positioned within a grid pattern, for example, grid pattern 302 shown in FIG. 3B. Thus, instead of the grid pattern 301 which only includes 4 antennas (e.g., the 4 antennas from the scanning antenna array 114) within the 4×4 grid pattern, the grid pattern 302 includes 8 antennas within the 4×4 grid pattern 302. In this example, each of the 8 antennas in the grid pattern 302 make up a sparse array; however, by placing the 8 antennas in specific locations within the 4×4 grid pattern combined with the ability of the 8-channel multiplexer 104 to select which 4 of the 8 antennas signals are passed to the 4-channel SDR 106 at any given time, the 8 antennas within the grid pattern 302 act as 1×4 ULA, a 1D sparse array, or a 2D sparse array at any given moment. Further, by placing the 8 antennas in specific locations within the grid pattern 302, multiple 1×4 ULAs and multiple sparse arrays are achieved from the 8 antennas, enabling the system to select from several different configurations. For example, by selecting the 4 antennas at coordinates (1,1), (2,1), (3,1), and (4,1) in the grid pattern 302, a 1×4 ULA is achieved. In another example, by selecting (1,1), (1,4), (4,1), and (4,4) in the grid pattern 302, a sparse antenna array is achieved.

In some examples, as long as 4 of the 8 antennas are placed in a straight line (e.g., diagonally or along the x or y axis) at least one ULA is achieved along with multiple different sparse arrays. FIGS. 3B-3F illustrate various configurations in which at least 4 antennas of the 8 antennas in the respective grid patterns 302-306, when selected, act as a ULA. In some examples, such as in FIGS. 3B and 3C, multiple ULAs can be achieved in grid patterns 302 and 303 by selecting only 4 antennas.

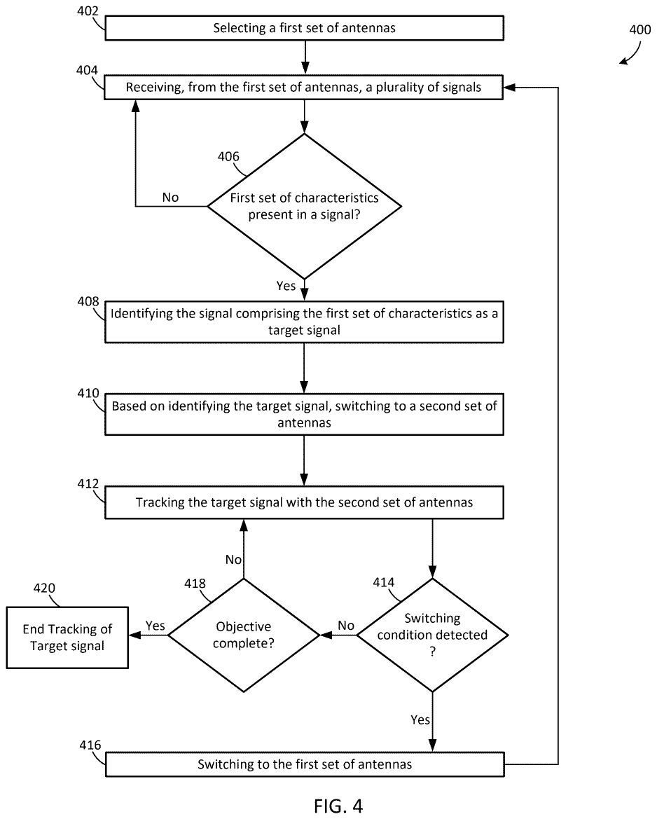

With reference now to FIG. 4, a flowchart illustrating an example of a method 400 of operations, functions, and/or the like of the antenna system 100 (FIG. 1) and the antenna architecture 200 (FIG. 2) for switching dynamically between a first set of antennas and a second set of antennas using minimal hardware resources is provided. At 402, the RFFE board 102 selects the first set of antennas based on the first set of antennas being configured to perform broad area scanning and the second set of antennas are configured to perform a more focused/targeted area of scanning. In some examples, the RFFE board 102 selects the first set of antennas when initially starting to scan for signals to efficiently detect, locate, and engage a target signal.

At 404, a plurality of signals is received, by the RFFE board 102, from the first set of antennas and, at 406, each of the plurality of signals is processed to determine if a first set of characteristics are present in one or more of the signals. For example, if a particular GPS signal is to be targeted, the first set of characteristics includes a particular L-band frequency, a unique code, a particular navigation message, continuous signal, pulsed signal, intermittent signal, and/or a signal strength.

At 408, a signal comprising the first set of characteristics is identified as a target signal. In some examples, the first set of characteristics is a subset of the characteristics of a signal. For example, with respect to a GPS signal, the first set of characteristics includes one or more of a particular L-band frequency, a unique code, a particular navigation message, continuous signal, pulsed signal, intermittent signal, and/or a signal strength.

At 410, based on identifying the target signal, the RFFE board 102 switches to the second set of antennas (e.g., the targeting antenna array 112), which performs a more focused/targeted area of scanning enabling focus on the direction of the target signal. In some examples, the RFFE board 102 switches to the second set of antennas immediately when the target signal is identified. In some examples, the RFFE board 102 does not switch to the second set of antennas until a particular period of time has elapsed. That is, in this example, the RFFE board 102 uses the first set of antennas until expiration of a timed period regardless of how soon a targeting signal is identified. In some examples, the RFFE board 102 waits a threshold period of time after identifying the target signal before switching to the second set of antennas. In this example, this delay enables the RFFE board 102 to determine whether the target signal is the best target signal by continuing to scan and process other signals. For example, while a target signal has already been identified at 406, if one of the first set of characteristics is signal strength, another target signal (e.g., another signal that includes the first set of characteristics) with even better signal strength may be identified. As such, the RFFE board 102 may determine that the other target signal with increased signal strength replaces the originally identified target signal.

At 412, the target signal is tracked with the second set of antennas. For example, using phase and amplitude differences between signals (from the target signal) received by individual antennas in the second set of antennas, the RFFE board 102 estimates a direction from which the target signal is coming by, for example, steering a beam in multiple directions to identify a strongest signal, measuring phase differences between antennas in the first set of antennas, and/or using models to estimate signal direction. After determining a direction of the target signal, the second set of antennas use beamforming to “focus” on that direction by, for example, adjusting a phase and amplitude of the signals at each antenna in the second set of antennas to constructively interfere in the desired direction, creating a directional beam and/or using signal processing to form multiple simultaneous beams or dynamically track the target signal. In some examples, the RFFE board 102 continuously updates the direction of arrival (DOA) estimates and the beam from the second set of antennas is dynamically steered (e.g., in real time) to maintain focus on the target signal.

At 414, it is determined whether a switching condition has been detected. In some examples, a switching condition which causes the RFFE board 102 to switch from the second set of antennas to the first set of antennas, is a time period. Thus, after the second set of antennas have been tracking the target signal for a defined period of time, the switching condition is met. In some examples, the period of time is based on percentage of how long the second set of antennas have been used compared to the first set of antennas. In this example, the second set of antennas are used 80% of the time while the first set of antennas are used 20% of the time. In another example, the second set of antennas are used between 90% of the time and 60% of the time and thus the first set of antennas are used between 10% of the time and 40% of the time. In some examples, the switching condition is signal strength. Thus, when the signal strength of the target signal falls below a defined threshold, the switching condition is met. In some examples, the switching condition is based on resource optimization (e.g., the switching condition is a power/fuel level) wherein switching from the second set of antennas to the first set of antennas allocates signal processing resources more efficiently and/or ensures optimal utilization of electronics thereby using less power/fuel. In some examples, the switching condition is an environmental condition such as signal interference, changes in weather, object obstruction, noise levels, and/or changes in the flight path that necessitate adjustments between scanning and targeting modes to maintain effective communication and data integrity. In some examples, the switching condition is based on dynamic repositioning as the mobile platform moves through its flight path. The positional advantage of alternative beacons may change, justifying a switch to support optimal trajectory and communication coherence. Further, a source of the target signal may become subject to interference or jamming, necessitating a selection of an alternate target signal with adequate signal integrity to maintain reliable targeting.

In some examples, the switching condition is based on a frequency of the target signal. That is, different frequencies may necessitate distinct approaches to the switching condition due to factors such as propagation characteristics, interference susceptibility, and the precision required for tracking. For example, for higher frequency signals, the RFFE board 102, and the switching conditions being applied, prioritize configurations that minimize path loss and maximize directional gain. This is because high frequencies generally have limited propagation range and are more affected by atmospheric attenuation. Conversely, for lower frequency signals, the RFFE board 102, and the switching conditions, are focused on broader beam coverage and enhanced noise filtering, given their greater resilience to environmental conditions but higher susceptibility to interference.

In some examples, the switching condition is to add or delete a set of fixed filters (e.g., high-pass, low-pass, band-pass, or band-stop) to mitigate any degradation of signal detection. In some examples, the set of fixed filters are optimally selected and inserted into the antenna network as user and mission conditions change. In some examples, the set of fixed filters are inserted to specifically detect or ignore certain signals and frequencies that would otherwise interfere with a more standard and broadband capture bandwidth of typical antennas.

At 416, when the switching condition is detected, the RFFE board 102 switches back to the first set of antennas and the process repeats at step 404. That is, at 404, based on the switching condition, the target signal from step 408 is still considered the target signal or the target signal was lost. Either way, at 404, a plurality of signals is received and, at 406, it is determined whether the first set of characteristics is present in a signal from the plurality of signals. In some examples, the target signal was lost at 414 and thus, at 406, a new target signal is attempted to be identified. In some examples, the target signal was not lost at 414 but a switching condition still caused a switch from the second set of antennas to the first set of antennas. As such, at 406, a determination is made as to whether the current target signal is still the target signal to be tracked. For example, when the switching condition at 414 is a signal strength of the target signal falling below a threshold, then, at 406 it is determined whether the signal strength of the target signal still satisfies the first set of characteristics and/or whether there is another signal that satisfies the first set of characteristics better than that current target signal. For example, the other signal satisfies the same first set of characteristics as the current target signal but has a stronger signal strength. Based on the decision made at 406, the process continues to 408 as described above.

Referring back to 414, if a switching condition is not detected, then the RFFE board 102 determines, at 418, whether an objective is complete and at 420, when it is determined that the objective is complete, the process ends. In some examples, the objective is associated with a source of the target signal. In some examples, the objective is based on the type of operation or application of the mobile platform comprising the RFFE board 102 and the first set of antennas and the second set of antennas. For example, a search and rescue objective is to identify a location of a source of the target signal, to capture an image of an area surrounding the source of the target signal, or to deploy objects such as resources (e.g., food, water, equipment) to a location near or at the source of the target signal.

At 418, if it is determined that the objective is not complete, then the process continues back at step 412 wherein the target signal is tracked by the second set of antennas. In some examples, the RFFE board 102 maintains use of the second set of antennas for tracking the target signal without ever switching to the first set of antennas. That is, the switching condition at 414 was never detected and thus the second set of antennas track the target signal until, for example, an objective has been complete at 418.

In some examples, the switching condition at 414 is based on whether the RFFE board 102 has previously switched from the second set of antennas to the first set of antennas (at 416) previously with respect to the current target signal being tracked. For example, one of the switching conditions at 414 is a determination that this is the first time the tracking of the current target signal has reached step 414. Thus, even though no other switching condition has been satisfied, the fact that the RFFE board 102 has not yet switched from the second set of antennas to the first set of antennas, while tracking the current target signal, results in the RFFE board 102 switching to the first set of antennas at 416. In this example, the RFFE board 102 switches from the second set of antennas to the first set of antennas at least once while tracking the current target signal.

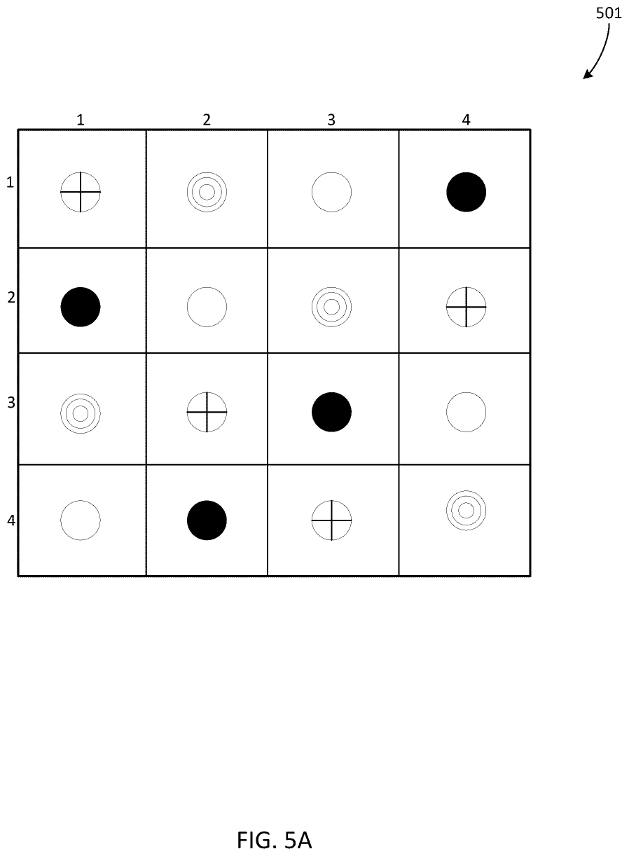

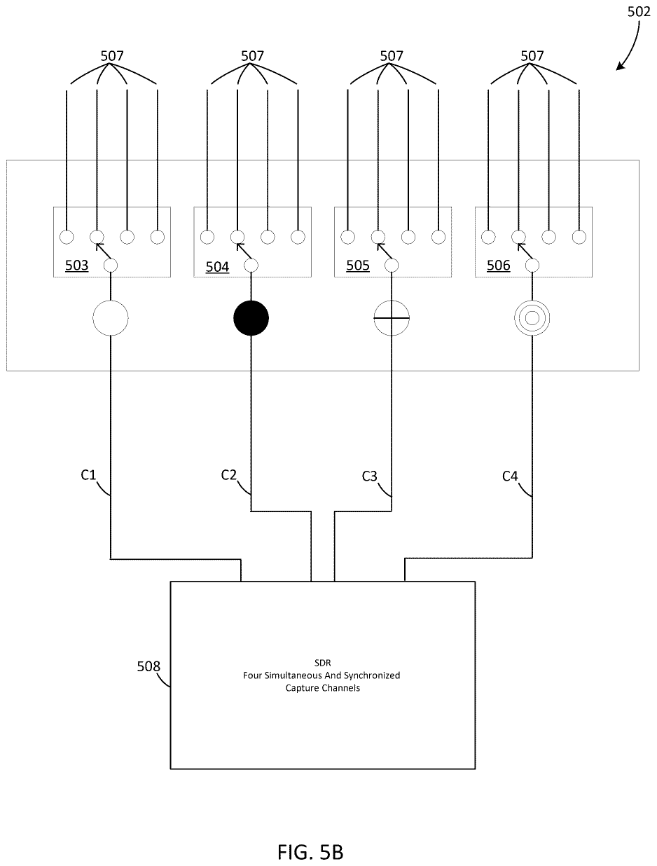

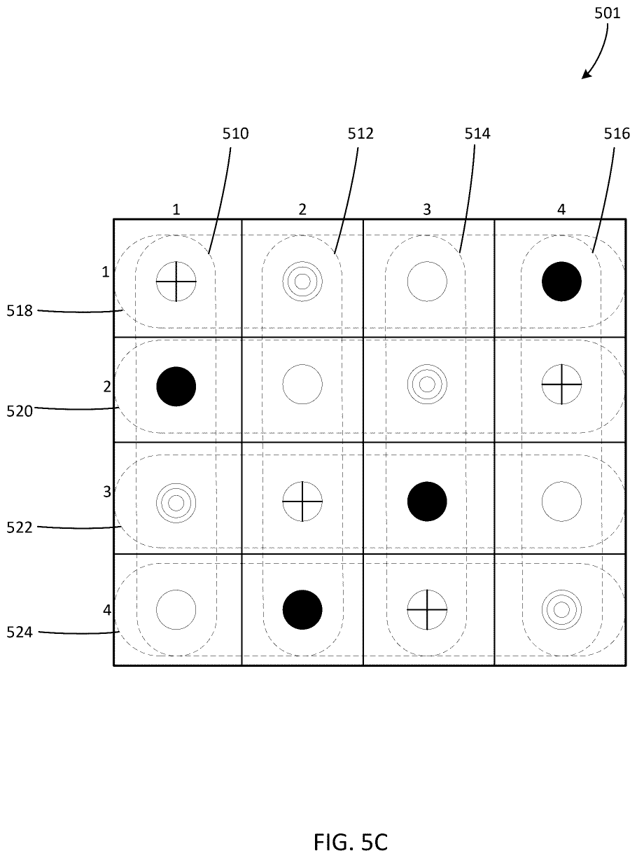

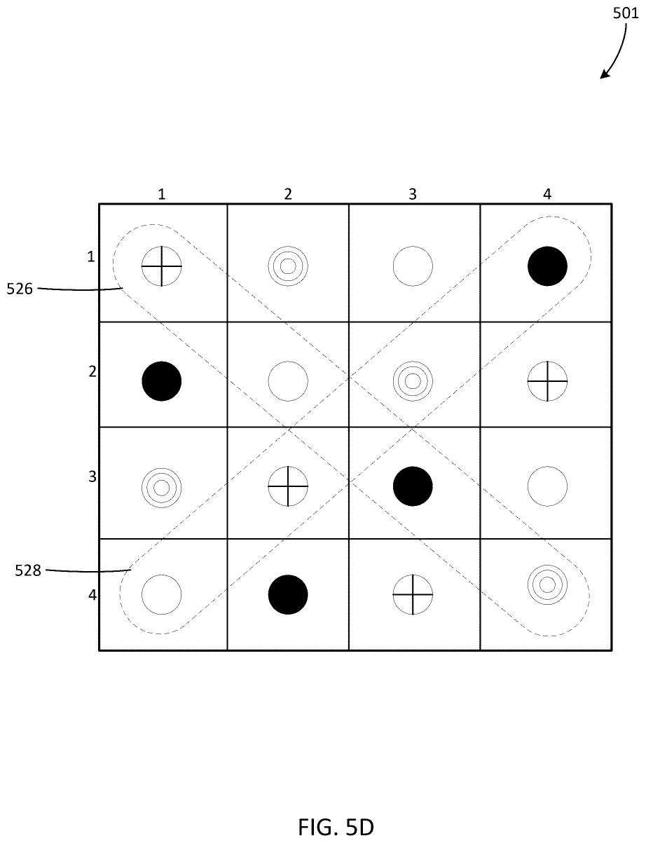

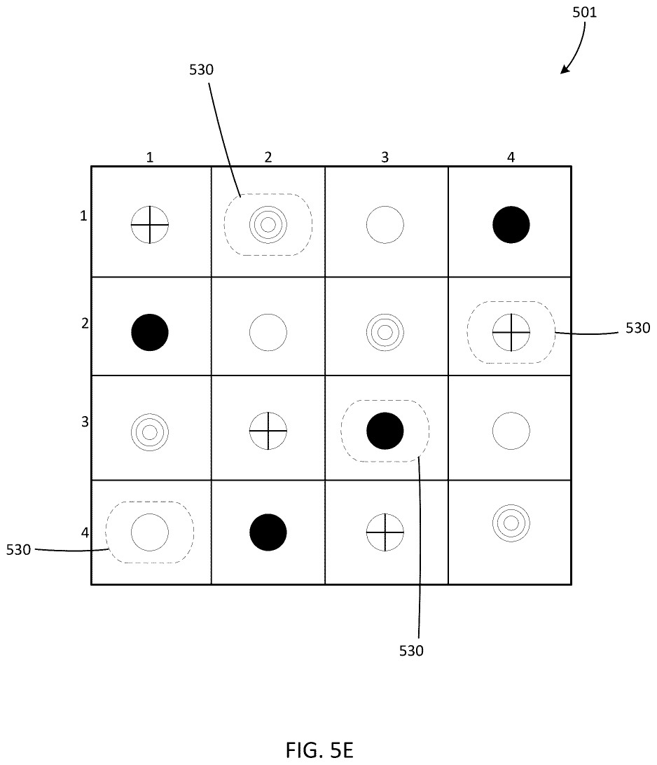

With reference now to FIG. 5A, a 16-element antenna 501 is provided. The 16-element antenna is based on antenna multiplexing being extended and expanded by one level to, for example, 16:4. That is, for the 16-element antenna 501, a multitude of four antenna groups (e.g., 503, 504, 505, and 506) or combinations of up to four antenna connections 507 may be selected and routed to an SDR 508 via a 16:4 RF multiplexer 502 as shown in FIG. 5B. As such, the 16:4 RF multiplexer 502 enables any of the four connections available to each channel (e.g., C1, C2, C3, and C4) to be selected independently since each is connected to a single antenna. As such, the 16-element antenna 501 with four groups of four antenna connections selected and routed to the SDR 508 via the 16:4 RF multiplexer 502 enables more combinations than that provided by the 8×4 antenna array (e.g., the combination of the targeting antenna array 112 and the scanning antenna array 114) of FIG. 2.

As shown in FIG. 5C, the 16-element antenna 501 provides for up to eight ULAs, for example, ULAs 510-524. In addition, as shown in FIG. 5D, the 16-element antenna 501 enables diagonal arrays, such as diagonal arrays 526 and 528. These exemplary arrays provide advantages of selecting offset phase discriminations of the orthogonal ULAs which can be used to determine potential phase ambiguities.

Further, as shown in FIG. 5E, in some examples the 16:4 RF multiplexer 502 is used to select a number of different sparse arrays, such as sparse array 530. This capability along with advanced signal processing is used in some examples to solve for greater antenna angular accuracy, side lobe cancellation, and phase ambiguity resolution.

### Exemplary Operating Environment

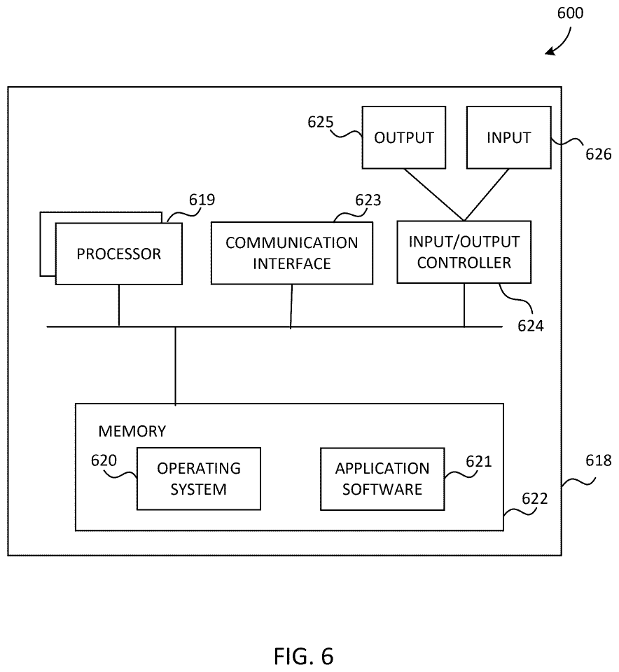

The present disclosure is operable with a computing apparatus according to an embodiment as a functional block diagram 600 in FIG. 6. In an example, components of a computing apparatus 618 are implemented as a part of an electronic device according to one or more embodiments described in this specification. The computing apparatus 618 comprises one or more processors 619 which may be microprocessors, controllers, or any other suitable type of processors for processing computer executable instructions to control the operation of the electronic device. Alternatively, or in addition, the processor 619 is any technology capable of executing logic or instructions, such as a hard-coded machine. In some examples, platform software comprising an operating system 620 or any other suitable platform software is provided on the computing apparatus 618 to enable application software 621 to be executed on the device.

In some examples, computer executable instructions are provided using any computer-readable media that is accessible by the computing apparatus 618. Computer-readable media include, for example, computer storage media and communications media. Computer storage media, such as the memory 622, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 622) is shown within the computing apparatus 618, it will be appreciated by a person skilled in the art, that, in some examples, the storage is distributed or located remotely and accessed via a network or other communication link (e.g., using a communication interface 623).

Further, in some examples, the computing apparatus 618 comprises an input/output controller 624 configured to output information to one or more output devices 625, for example a display (e.g., displaying a GUI) or a speaker, which are separate from or integral to the electronic device. Additionally, or alternatively, the input/output controller 624 is configured to receive and process an input from one or more input devices 626, for example, a keyboard, a microphone, or a touchpad. In one example, the output device 625 also acts as the input device. An example of such a device is a touch sensitive display. The input/output controller 624 may also output data to devices other than the output device, e.g., a locally connected printing device. In some examples, a user provides input to the input device(s) 626 and/or receives output from the output device(s) 625.

The functionality described herein can be performed, at least in part, by one or more hardware logic components. According to an embodiment, the computing apparatus 618 is configured by the program code when executed by the processor 619 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements. Any of the functions, operations, and/or the like of the systems, methods, and the like disclosed herein are, in some examples, performed automatically by one or more processors, modules, AI engines, models, and/or the like.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation (e.g., different steps) is within the scope of aspects of the disclosure.

The term “comprising” is used in this specification to mean including the feature(s) or act(s) followed thereafter, without excluding the presence of one or more additional features or acts. The terms “comprising,” “including,” and “having” are intended to be inclusive and mean that there can be additional elements other than the listed elements. In other words, the use of “including,” “comprising,” “having,” “containing,” “involving,” and variations thereof, is meant to encompass the items listed thereafter and additional items. Accordingly, and for example, unless explicitly stated to the contrary, implementations “comprising” or “having” an element or a plurality of elements having a particular property can include additional elements not having that property. Further, references to “one implementation” or “an implementation” are not intended to be interpreted as excluding the existence of additional implementations that also incorporate the recited features. The term “exemplary” is intended to mean “an example of”.

When introducing elements of aspects of the application or the examples thereof, the articles “a,” “an,” “the,” and “said” are intended to mean that there are one or more of the elements. In other words, the indefinite articles “a”, “an”, “the”, and “said” as used in the specification and in the claims, unless clearly indicated to the contrary, should be understood to mean “at least one.” Accordingly, and for example, as used herein, an element or step recited in the singular and preceded by the word “a” or “an” should be understood as not necessarily excluding the plural of the elements or steps.

The phrase “one or more of the following: A, B, and C” means “at least one of A and/or at least one of B and/or at least one of C.” The phrase “and/or”, as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally including elements other than B); in another implementation, to B only (optionally including elements other than A); in yet another implementation, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either,” “one of” “only one of” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

It is to be understood that the above description is intended to be illustrative, and not restrictive. For example, the above-described implementations (and/or aspects thereof) can be used in combination with each other. In addition, many modifications can be made to adapt a particular situation or material to the teachings of the various implementations of the application without departing from their scope. While the dimensions and types of materials described herein are intended to define the parameters of the various implementations of the application, the implementations are by no means limiting and are example implementations. Many other implementations will be apparent to those of ordinary skill in the art upon reviewing the above description. The scope of the various implementations of the application should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various implementations of the application, including the best mode, and also to enable any person of ordinary skill in the art to practice the various implementations of the application, including making and using any devices or systems and performing any incorporated methods. The patentable scope of the various implementations of the application is defined by the claims, and can include other examples that occur to those persons of ordinary skill in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A computerized method comprising:
receiving, from a first set of antennas, a plurality of signals;
identifying, from the plurality of signals, a target signal;
based on identifying the target signal, switching to a second set of antennas that provide increased directional tracking capabilities on the target signal than the first set of antennas;
tracking the target signal with the second set of antennas until a first switching condition is detected;
upon detecting the first switching condition, switching to the first set of antennas;
identifying the target signal with the first set of antennas until a second switching condition is detected;
upon detecting the second switching condition, switching to the second set of antennas; and
tracking the target signal with the second set of antennas until one of the following: a third switching condition is detected or an objective is completed.

2. The method according to claim 1, wherein the first set of antennas is a scanning antenna array.

3. The method according to claim 2, wherein the second set of antennas is a targeting antenna array.

4. The method according to claim 1, wherein first switching condition comprises one or more of the following: a signal strength of the target signal falling below a defined threshold, a resource condition, an environmental condition, and a predefined timing threshold.

5. The method according to claim 1, wherein the second switching condition is a confirmation that the target signal is still a current target signal based on a set of characteristics of the target signal.

6. The method according to claim 1, wherein switching to the second set of antennas from the first set of antennas occurs immediately following the target signal being identified.

7. The method according to claim 1, wherein a set of characteristics of the target signal comprises one or more of the following: a signal strength, a signal frequency, and message within the target signal.

8. A system comprising:
a scanning antenna array;
a targeting antenna array;
a radio frequency front-end (RFFE) board coupled to the scanning antenna array and the targeting antennas array, the RFFE board comprising:
an 8-channel or a 16-channel RF multiplexer configured for channel selection between the scanning antenna array and the targeting antenna array;
a 4-channel software-defined radio (SDR) configured for processing digital signals received from the RF multiplexer;
a processor; and
a memory comprising computer executable instructions that, when executed by the processor, cause the processor to perform the following operations:
receiving, from the scanning antenna array, a plurality of signals;
identifying, via the SDR, a target signal from the plurality of signals;
based on identifying the target signal, switching, by the RF multiplexer, to the targeting antenna array to provide increased directional tracking capabilities on the target signal than the scanning antenna array;
tracking, via the SDR, the target signal with the targeting antenna array until a first switching condition is detected;
upon detecting the first switching condition, switching, by the RF multiplexer, to the scanning antenna array;
identifying, via the SDR, the target signal until a second switching condition is detected;
upon detecting the second switching condition, switching, by the RF multiplexer, to the targeting antenna array; and
tracking, via the SDR, the target signal with the targeting antenna array until one of the following: a second switching condition is detected or an objective is completed.

9. The system according to claim 8, wherein first switching condition comprises one or more of the following: a signal strength of the target signal falling below a defined threshold, a resource condition, an environmental condition, and a predefined timing threshold.

10. The system according to claim 8, wherein the scanning antenna array provides a broader area of scanning than the targeting antenna array.

11. The system according to claim 8, wherein the scanning antenna array is a sparse array of antennas.

12. The system according to claim 8, wherein the targeting antenna array is a uniform linear array of antennas.

13. The system according to claim 8, wherein a set of characteristics of the target signal comprise one or more of the following: a signal strength, a signal frequency, and message within the target signal.

14. The system according to claim 8, wherein switching to the targeting antenna array from the scanning antenna array is performed immediately following the target signal being identified.

15. A non-transitory computer-readable medium comprising computer-executable instructions that, when executed by a processor, cause the processor to perform the following operations:
receiving, from a first set of antennas, a plurality of signals;
identifying, from the plurality of signals, a target signal comprising a set of characteristics;
based on identifying the target signal comprising the set of characteristics, switching to a second set of antennas that provide increased directional tracking capabilities on the target signal than the first set of antennas;
tracking the target signal with the second set of antennas until a first switching condition is detected;
upon detecting the first switching condition, switching to the first set of antennas;
identifying the target signal with the first set of antennas until a second switching condition is detected;
upon detecting the second switching condition, switching to the second set of antennas; and
tracking the target signal with the second set of antennas until one of the following: a third switching condition is detected or an objective is completed.

16. The non-transitory computer-readable medium according to claim 15, wherein the first set of antennas are a scanning antenna array.

17. The non-transitory computer-readable medium according to claim 16, wherein the second set of antennas are a targeting antenna array.

18. The non-transitory computer-readable medium according to claim 15, wherein first switching condition comprises one or more of the following: a signal strength of the target signal falling below a defined threshold, a resource condition, an environmental condition, and a predefined timing threshold.

19. The non-transitory computer-readable medium according to claim 15, wherein the second switching condition is a confirmation that the target signal is still a current target signal based on the set of characteristics.

20. The non-transitory computer-readable medium according to claim 15, wherein switching to the second set of antennas from the first set of antennas is immediately following the target signal being identified.
